(19) United States
(12) Patent Application Publication
(10) Pub. No.: US 2019/0291149 A1
(43) Pub. Date: Sep. 26, 2019

(54) Keycard sanitizer

(71) Applicant: Matthew Damskov, Spokane Valley, WA (US)

(72) Inventor: Matthew Damskov, Spokane Valley, WA (US)

(21) Appl. No.: 15/927,376

(22) Filed: Mar. 21, 2018

(51) Int. Cl. B08B 7/04; G06K 19/06; B08B 1/00; B08B 3/04; B08B 7/00

(52) U.S. Cl. CPC B08B 7/04; G06K 19/06196; B08B 7/0057; B08B 3/041; B08B 1/006

(57) ABSTRACT

The invention is directed to a keycard sanitizer. The sanitizer employs one or more of three different methods to sanitize keycards turned in by customers: ultraviolet light projectors, sanitizer sponges, and sanitizer sprayers. A plurality of drying sponges and a sanitizer drain are also provided. Preferably, a detachable feeder tray and a detachable receiver tray are provided to feed keycards into a card entrance slot on the sanitizer, and receive keycards as they are expelled from an exit slot on the sanitizer, respectively. The sanitizer enables the management of a business to sanitize keycards and reissue the keycards to incoming customers, saving the expense of discarding and replacing used keycards.

### CROSS-REFERENCE TO RELATED APPLICATIONS

This application relates back to, and claims the priority of Provisional Patent Application No. 62/475,084 filed on Mar. 22, 2017.

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to hospitality equipment and accessories, and in particular to a keycard sanitizer. It has become customary in many businesses to issue keycards to guests. Each keycard provides a magnetic strip which allows the guest to unlock his or her assigned secured space, such as a guest room or locker. Unfortunately, as with most other physical amenities, keycards acquire diseases pathogens when they are touched or handled by guests. Discarding the keycards after their use causes significant costs for management.

A search of the prior art reveals various devices which have been developed to provide the features of a sanitizer, which is capable of sanitizing various items quickly and easily. None are closely related to the present invention, but several include features which resemble those of the present invention. Each has proven to be less than satisfactory for the present purpose in its own way.

Access control system and sanitizing station, U.S. Patent Appl. No. 2008/0136649A1 (priority Dec. 12, 2006), provides a system for controlling access and recording identities of persons who have been allowed or denied access to controlled access areas. A sanitization station which controls access to protected areas and records who has been allowed to enter and who has been denied entry to the area. Improved sanitization stations providing greater safety and efficacy as well as efficient and clean operation. Access control systems and stations that record attempts to access protected areas through the station, permit or deny access to the protected based on preset rules or permissions, and also record compliance with requirements for access to the protected area by authorized persons. The systems and stations may trigger local or remote alarms when an unauthorized person enters or attempts to enter a protected area, or fails to comply with conditions required to gain admission to the protected area.

Hand sterilizing apparatus and method, U.S. Pat. No. 7,285,114 (priority Jan. 10, 2003), provides devices and a method promoting the convenient use of hand sterilizing fluids and gels applied to reduce the hand-borne transmission of pathogens. This invention of a convenient, wrist-mounted dispenser of hand sterilizing fluids in a blister package format advances the use of such materials to effectively control the spread of hand-borne pathogens.

Cart and basket washer and method, U.S. Patent Appl. No. 2009/0050174A1 (priority Aug. 20, 2007), provides a cart or shopping basket washer which is configured to wash one or more carts or shopping baskets. The cart or shopping basket washer may include self-propelled apparatuses to treat a substantially stationary cart or shopping basket, or may include a conveying mechanism to propel a cart or shopping basket through one or more substantially stationary washing stations. The cart or shopping basket washer may include provisions from accepting commands from non-trained persons, for receiving payment, and for receiving indication of a loyalty relationship. The cart or shopping basket washer may include sensors and logic to ensure the safety of people and property.

Sanitizing apparatus for milking machines, U.S. Pat. No. 3,461,845 (priority Jan. 23, 1967), provides a milking machine, comprising a central milk line, connected to a suitable source of vacuum and collection tank, and communicative with milk claws through feeder lines. Communication through the feeder lines is controlled by a spigot valve of a type well known in the art. The milk claw assembly comprises a hollow body having a nipple communicating with the feeder line of milk claws around the upper periphery thereof. A teat cup or inflation is connected to each claw through a milk tube. The milk is collected in the body of a claw assembly and transmitted through the feeder lines to the central milk line for collection. A sanitizing fluid container, maintained under pressure by a pump or other suitable means, is connected to a central sanitizing line which, in turn, is connected, through branch conduits, to a dosage device. The dosage device is connected to a sanitizing line which in turn communicates through a nipple with an annular conduit disposed around the claw body adjacent to the nipples.

Telephone cleaner-sanitizer, U.S. Pat. No. 3,654,165 (priority Sep. 10, 1970), provides a highly solvent, quick-drying, safe, but persistently disinfectant chemical compound in the form of a solution specifically designed for periodic wiping, cleaning and disinfecting of telephone instruments in a minimum of time and without corrosive or cumulative-residue effects, together with designation of a special material in combination therewith for hand application of the chemical to telephone instruments.

A device that enables the hospitality staff of any business to quickly and easily sanitize returned keycards would be well received. A keycard sanitizer, which enables the user to easily sanitize a large quantity of keycards by feeding the keycards into a card entrance slot, would resolve this problem.

### SUMMARY OF THE INVENTION

Accordingly, the invention is directed to a keycard sanitizer. The sanitizer employs one or more of three different methods to sanitize hotel and motel keycards turned in by guests: ultraviolet light projectors, sanitizer sponges, and sanitizer sprayers. A plurality of drying sponges and a sanitizer drain are also provided. Preferably, a detachable feeder tray and a detachable receiver tray are provided to feed keycards into a card entrance slot on the sanitizer, and receive keycards as they are expelled from an exit slot on the sanitizer, respectively. The sanitizer enables the management of a hotel or motel to sanitize keycards and reissue the keycards to incoming guests, saving the expense of discarding and replacing used keycards.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWINGS

The accompanying drawings are included to provide a further understanding of the invention and are incorporated into and constitute a part of the specification. They illustrate one embodiment of the invention and, together with the description, serve to explain the principles of the invention.

FIG. 1 is a front view of the first exemplary embodiment, displaying the sanitizer 10, the cover 11, the activation button 12, the feet apertures 13, and the card entrance slot 14.

FIG. 2 is a rear view of the first exemplary embodiment, displaying the sanitizer 10, the cover 11, the activation button 12, the feet apertures 13, and the card exit slot 15.

FIG. 3 is a left side view of the first exemplary embodiment, displaying the sanitizer 10, the cover 11, the activation button 12, and the feet apertures 13.

FIG. 4 is a right side view of the first exemplary embodiment, displaying the sanitizer 10, the cover 11, and the feet apertures 13.

FIG. 5 is a front transparency view of the first exemplary embodiment, displaying the sanitizer 10, the activation button 12, the sanitizer sprayers 16, the rollers 17, and the reservoir 18.

FIG. 6 is a rear transparency view of the first exemplary embodiment, displaying the sanitizer 10, the activation button 12, the sanitizer sprayers 16, the rollers 17, and the reservoir 18.

FIG. 7 is a front perspective transparency view of the first exemplary embodiment, displaying the sanitizer 10, the activation button 12, the sanitizer sprayers 16, the rollers 17, and the reservoir 18.

FIG. 8 is a rear perspective transparency view of the third exemplary embodiment, displaying the sanitizer 10, the activation button 12, the sanitizer sprayers 16, the rollers 17, and the reservoir 18.

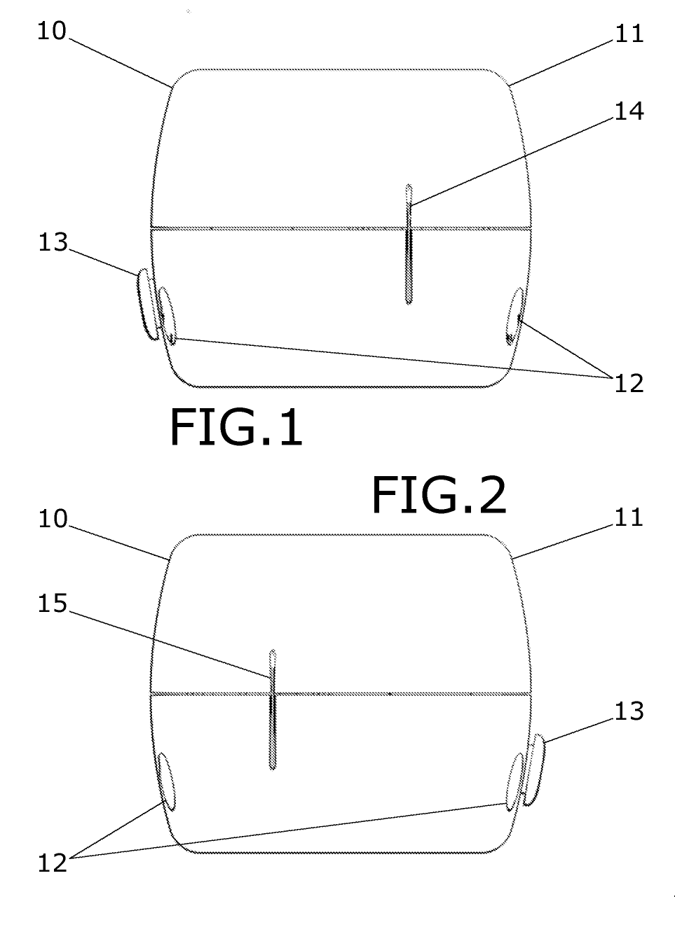

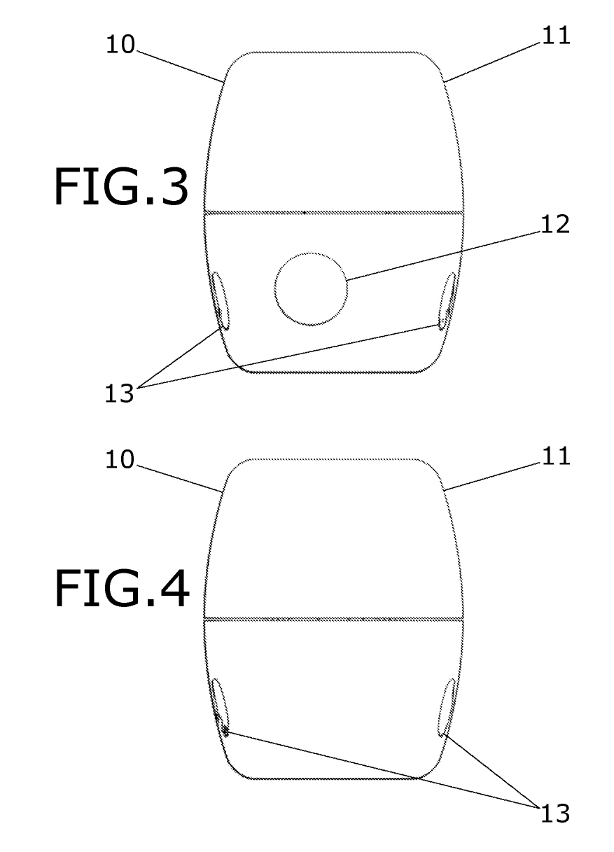

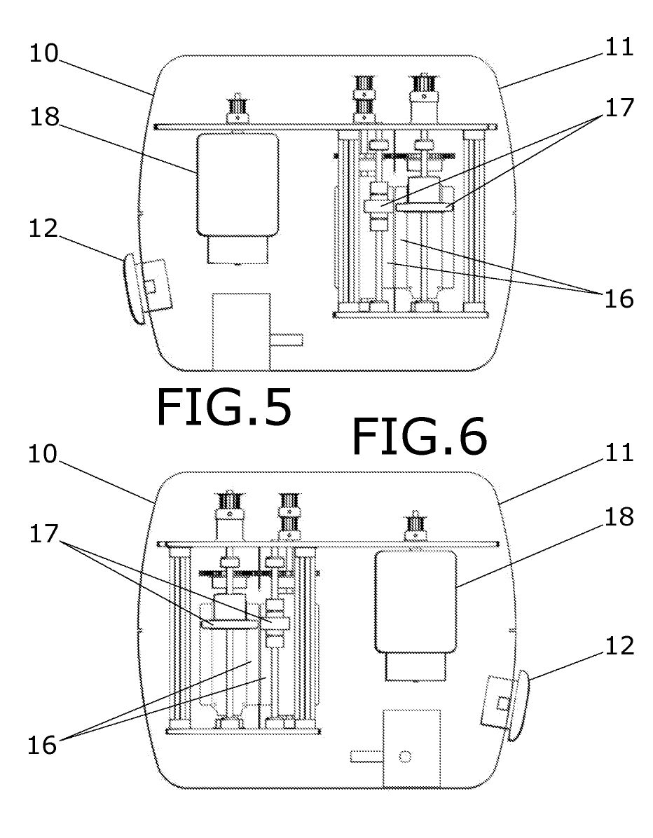

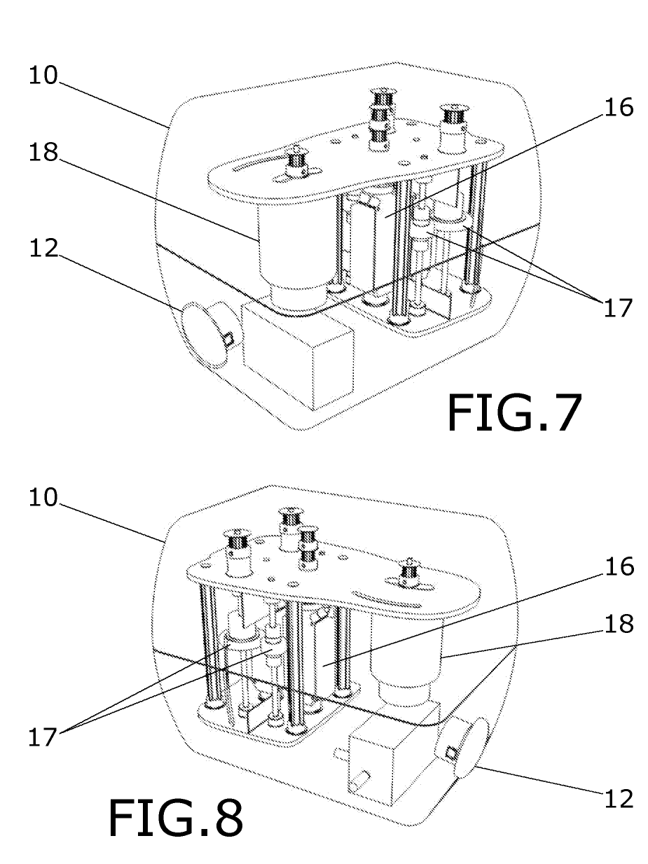

### DETAILED DESCRIPTION OF THE INVENTION

Referring now to the invention in more detail, the invention is a keycard sanitizer 10. The sanitizer 10 enables the management of a hotel or motel to sanitize keycards and reissue the keycards to incoming guests, saving the expense of discarding and replacing used keycards. The sanitizer may also be used by banks and other financial institutions, hospitals, casinos, colleges and universities, and similar institutions where encoded cards are temporarily provided to customers and other non-staff persons.

The sanitizer 10 is mounted on four flexible feet, which may be extended vertically from feet apertures 13, and provides a removable cover 11. The sanitizer 10 employs one or more of three different methods to sanitize hotel and motel keycards turned in by guests: ultraviolet light projectors, sanitizer sponges, and sanitizer sprayers 16. A plurality of drying sponges are also provided. A detachable feeder tray and a detachable receiver tray may also be provided to feed keycards into a card entrance slot 14 on the front surface of the sanitizer 10, and receive keycards as they are expelled from an exit slot 15 on the rear surface of the sanitizer 10, respectively.

Electric servomotors power a series of rollers 17 which propel the keycards through the sanitizer 10, from the card entrance slot 14, through the sanitizing method or methods provided, through the drying sponges, and out through the exit slot 15. A detachable AC power cord is also provided, which may be inserted into a power cord socket provided on the side surface of the sanitizer 10.

The first exemplary embodiment is a sanitizer 10 which provides sanitizer sprayers 16. A cover 11 is provided, which may be opened to enable the replenishment of a reservoir 18 of sanitizing fluid within the sanitizer 10. The sanitizer fluid is applied to both surfaces of the keycard by the sanitizer sprayers 16, and excess fluid drains into a sanitizer drain, which is provided. Internal components may be configured differently from the configuration shown in the drawings.

The second exemplary embodiment is similar in structure and function to the first exemplary embodiment, with the following modifications. Instead of sprayers 16, the second exemplary embodiment provides sanitizer sponges. The sanitizing fluid from the reservoir 18 moistens the sanitizer sponges, which then apply the sanitizing fluid to the keycard.

The third exemplary embodiment is similar in structure and function to the first exemplary embodiment, with the following modifications. Instead of sprayers 16, the third exemplary embodiment provides ultraviolet light projectors, which are powered by the power cord. In the third exemplary embodiment, the reservoir 18 and the sanitizer drain 17 are removed from the design.

To use the first, second, or third exemplary embodiment, the user may feed returned keycards by hand into the card entrance slot 14, and remove sanitized keycards from the exit slot 15 by hand as they are expelled. Alternatively, the user may attach the feeder tray and the receiving tray to the sanitizer 10, insert one or more keycards into the feeder tray 19, and remove the sanitized keycards from the receiving tray 20 upon completion.

The sanitizer 10, the cover 11, the card entrance slot 14, the exit slot 15, the sanitizer sprayers 16, the reservoir 18, the ultraviolet light projectors, the sanitizer drain, the power cord socket, the feeder tray, the receiving tray, and the servomotors are preferably manufactured from rigid, durable materials, such as steel, aluminum alloy, and plastic. The feet and the rollers 17 are preferably manufactured from a flexible, durable material such as rubber, plastic, or silicon. The power cord is preferably manufactured from braided copper alloy wire sheathed in plastic.

Components, component sizes, and materials listed above are preferable, but artisans will recognize that alternate components and materials could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. A keycard sanitizer which is mounted on four flexible feet and employs one or more of three different methods to sanitize keycards turned in by customers: ultraviolet light projectors, sponges, and sprayers, with a plurality of drying sponges being also provided.

2. The keycard sanitizer of claim 1, wherein preferably, a detachable feeder tray and a detachable receiver tray are provided to feed keycards into a card entrance slot on the front surface of the sanitizer, and receive keycards as they are expelled from an exit slot one the rear surface of the sanitizer, respectively.

3. The keycard sanitizer of claim 1, wherein electric servomotors power a series of rollers which propel the keycards through the sanitizer, from the card entrance slot, through the sanitizing method or methods provided, through the drying sponges, and out through the exit slot.

4. The keycard sanitizer of claim 1, wherein a detachable AC power cord is also provided, which may be inserted into a power cord socket provided on the side surface of the sanitizer.

5. The keycard sanitizer of claim 1, wherein the user may feed returned keycards by hand into the card entrance slot, and remove sanitized keycards from the exit slot by hand as they are expelled

6. The keycard sanitizer of claim 1, wherein alternatively, the user may attach the feeder tray and the receiving tray to the sanitizer, insert one or more keycards into the feeder tray, and remove the sanitized keycards from the receiving tray upon completion.

7. The keycard sanitizer of claim 1, wherein sprayers are provided, applying sanitizer fluid to both sides of the keycard, with excess fluid drains into a sanitizer drain, which is provided; and a door is provided on the top surface, which may be opened to enable the replenishment of a reservoir of sanitizing fluid within the sanitizer.

8. The keycard sanitizer of claim 4, wherein sponges are provided which become moistened by the sanitizing fluid from the reservoir, and then apply the sanitizing fluid to the keycard.

9. The keycard sanitizer of claim 4, wherein ultraviolet light projectors, which are powered by the power cord, are provided; the door, the reservoir, and the sanitizer drain are removed from the design.
